(19) United States
(12) Patent Application Publication
(10) Pub. No.: US 2007/0283268 A1
(43) Pub. Date: Dec. 6, 2007

(54) Advertising delivery

(76) Inventors: Adam L. Berger, Pittsburgh, PA (US); Kevin Serafini, Gibsonia, PA (US)

Correspondence Address: FISH & RICHARDSON PC, P.O. BOX 1022, MINNEAPOLIS, MN, 55440-1022, US

(21) Appl. No.: 11/447,443

(22) Filed: Jun. 6, 2006

(51) Int. Cl. G06F 3/00

(52) U.S. Cl. 715/716

(57) ABSTRACT

Among other things, information associated with presentation of video material on a presentation device to a single user is used to select video material to be presented to the user on another presentation device.

### BACKGROUND

This description relates to advertising delivery.

A television advertisement (which we also sometimes call a commercial or simply an ad) typically is spliced into a program either at a network production center when the program content is produced or at a regional head end (e.g., Comcast/Pittsburgh) before the program is delivered to the recipient device. A marker (e.g., a cue tone in an analog television signal or an embedded marker in a digital television signal) indicates a location in the signal at which the commercial is to be spliced. Region-specific commercials can be spliced into a given program at each regional head end.

A variety of devices (we sometimes call them end point devices) can be used to view a television or other video presentation, including cathode-ray tubes, large flat-screen LCD or plasma displays, cellular phones, personal digital assistants, portable gaming devices, console gaming devices, in-car entertainment units, and computers. Some of these devices (e.g. a computer) may have or acquire information that identifies or is otherwise associated with the person who is the user. The information may be obtained, for example, as a result of a login (on a computer), or at the time the device was provisioned or initialized (e.g., information accumulated by a cell phone supplier at when the cell phone is first delivered to the user). In case of a cell phone, a user's identity may be associated with the phone number or with a SIM card that can be moved from one phone to another.

In a system offered by Invidi, http://www.invidi.com/invidi_products.html, commercials are delivered as files separately from the programming (out of band) to an end device, where they are stored. Later, at certain points in a television program, the box will select one of the stored commercials (based on some selection criterion) and splice the commercial into the program. The commercials can be targeted to an individual end device at a particular time; the targeting may be based on (for example) previously-watched ads, the time of day, or previously-watched programs. Because the ads are inserted into the programming at the end device, the sequence in which ads are presented can be controlled to ensure that viewers see specified ads in a predetermined sequence.

### SUMMARY

In general, in an aspect, an audio or video item is selected to be presented on one occasion by an end point device to a user who is associated with the end point device, the selecting being based on information associated with a presentation of at least one other audio or video item at another end point device that is also associated with the user.

Implementations may include one or more of the following features. The selected audio or video item comprises an advertisement. The one other audio or video item comprises an advertisement. At least one of the end point devices comprises a cell phone, a personal digital assistant, or other handheld wireless device. The information associated with the presentation comprises the timing of the presentation, an identifier of the presentation, other audio or video content presented at the other endpoint device, information about the other endpoint device, or information about actions of the user. The information associated with the presentation is stored for use in connection with the selecting. The information is stored in one of the end point devices and/or in a location accessible to both of the end point devices. The information is received at the end point device directly or indirectly from the other end point device. The information is communicated during a license retrieval. Storage of the information is synchronized on both of the end point devices and at the accessible location. The selecting is based on the information as stored in the accessible location. The accessible location contains a user identifier and usage information for the user. The audio or video item is spliced into an audio or video stream. The audio or video stream comprises a television program and the audio or video item that is spliced comprises an advertisement. The selecting includes controlling a sequence in which multiple audio and video items are presented to the user at more than one of the end point devices. The sequence is controlled using a mutex. The information is communicated during a license retrieval.

In general, in an aspect, presentation to a user of two video advertisements at two different times and at two different presentation devices used by a single user is controlled so that one of the advertisements is reliably presented to the user before the other of the advertisements.

In general, in an aspect, information associated with presentation of video material on a presentation device to a single user is used to select video material to be presented to the user on another presentation device.

In general, in an aspect, data store information about advertisements that have been presented to users at different presentation devices, is stored in a centrally accessible data store information and used to select advertisements to be presented to the users at the different presentation devices.

In general, in an aspect, a single user of more than two devices at which video programs are to be presented to choose, independently for each device, can decide whether or not to permit the device to present advertisements to the user in connection with the video programs.

In general, in an aspect, an apparatus includes a data store to contain information about audio or video material presented to users of multiple presentation devices, the information including identifiers of the material presented, indications of times when the material was presented, and identifiers of the known users.

In general, in an aspect, an apparatus includes a handheld device on which advertisements are to be presented, the handheld device including a store containing information about presentations of advertisements that have been made to a user of the handheld device on other presentation devices.

Among the advantages of the approach summarized above are one or more of the following. Advertising can be targeted to an entire peer group of devices belonging to a person or a household, which addresses the fact that individuals and households are doing their television viewing on a wider range of different devices at different times and places. Thus, the advertising can be targeted more effectively and cleverly. An entire peer group of devices can be targeted because the techniques described above enable synchronization and sharing of information from all of the devices in the peer group. This ensures a consistent user experience among the devices and ensures availability at the advertising delivery system of all possible information for use in selecting which ads to deliver to which devices and when.

In general, in an aspect, a media file is selected to be presented on a user device based on a number of times the media file or another media file has been presented on the user device or on other devices of the user.

Implementations may include one or more of the following features. The media files comprise commercials. The user device comprises a handheld phone, a personal digital assistant, a laptop computer, or a cable/satellite set top box. The commercials have a predefined intended sequence of presentation. The selecting of the media file is based on media file presentation history stored other than on the user device.

Other aspects may include these and other features alone or in combination and 10 may be expressed as methods, apparatus, systems, program products, and in other ways.

Other advantages and features will become apparent from the following description and from the claims.

### DESCRIPTION

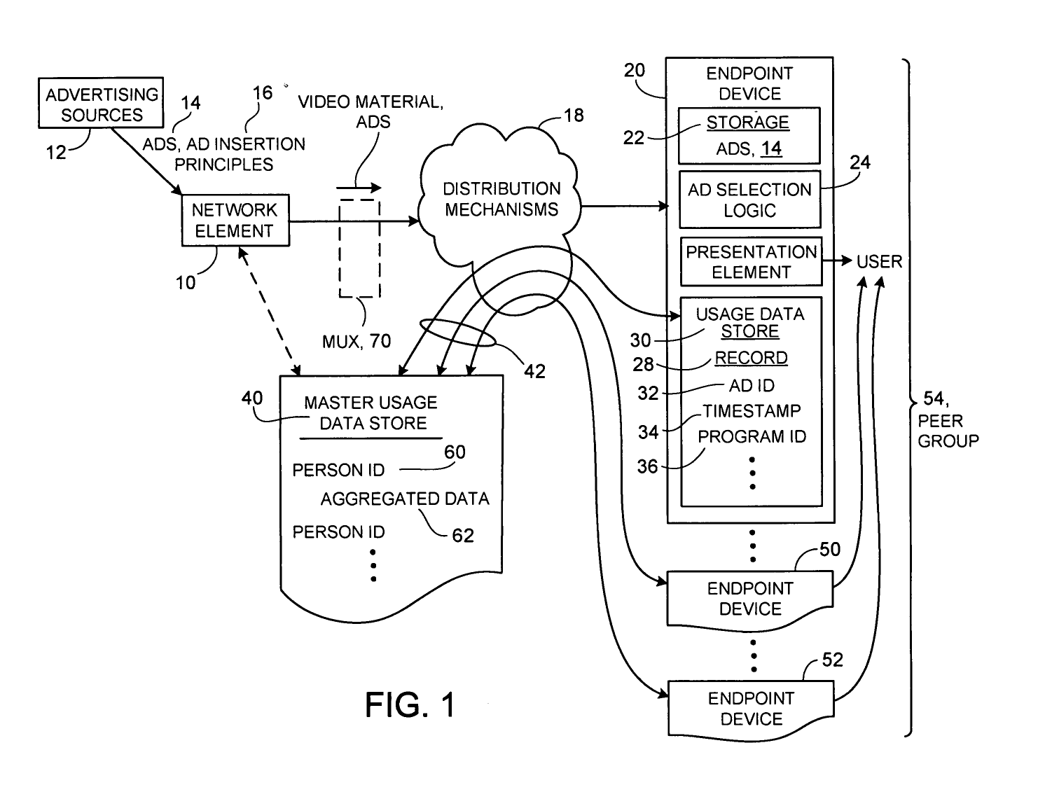

FIG. 1 is a block diagram.

By coordinating the delivery, storage, selection, and insertion of advertisements among two or more of a peer group of end point devices that are associated with a given individual or a household, an advertisement-delivery system can accommodate and take advantage of the fact that one viewer or household may have many devices on which he experiences television, radio, and other media material. In effect, the approach that we describe here allows advertisers to target ads not only to a specific regional market or even to a specific device, but also to a specific person or household.

The end devices that are associated with a given person (we typically use person to refer also to a household or other small group of related people who share some or all of the devices in a peer group of endpoint devices) and are used by the person during the course of a day or longer period can include home televisions (served by cable, satellite, or broadcast delivery systems, for instance), telephones, personal digital assistants, gaming consoles, portable gaming devices, and other devices. We call them together a peer group of end point devices. Sometimes we refer to the person who is associated with the peer group as the peer group owner.

At least some of the peer group devices are associated with identifier information about the person who owns them or normally uses them. Also, at least some of the peer group devices are able to insert ads locally by downloading, storing, and splicing the ads (in real time) into a television program or other video material. Although our description refers frequently to television programs and other video material, the approach described here may also be applied to radio programs and other audio material. References to television programs and video material are meant to refer also to radio programs and audio material. In addition we sometimes refer simply to video material as including television programs, video material, radio programs, and audio material.

Coordinating ad handling among peer group devices can provide a number of features.

For example, the sequencing of ads can be achieved across multiple devices in the peer group. This ensures an advertiser that the peer group owner will receive ads in a desired sequence even though the peer group owner migrates from device to device within the peer group.

For example, imagine that a car manufacturer wishes to subject each member of an audience to a sequence of ads: first a superficial product “teaser,” then a more revealing description of the product, and finally, pricing and local dealer information. Typical ad-insertion mechanisms using broadcast TV do not enable an advertiser to be sure each viewer has experienced the ads in the intended sequence. In the approach described here, sequencing can be managed across a peer group of devices. For instance, the peer group owner first may watch a first commercial in a sequence of Toyota ads on a home television, while eating breakfast. Later, the person may watch a second Toyota commercial (that was intended by the advertiser to be seen after the first commercial) on his phone while waiting at a coffee shop. Later, the person may watch a third Toyota commercial on his laptop computer at work. And so on.

The insertion of ads also can be adapted more effectively to the peer group owner and to information about his use of the peer group devices. Typical local ad insertion is based on observed user behavior, such as which shows and commercials have been viewed recently at a single device. By pooling data about the user's behavior as it occurs across multiple devices in the peer group—phone, PDA, laptop, gaming console—more data is available, and the quality of the ad insertion selections can be improved.

Interactive TV systems that allow users to provide feedback, for example, by asking for more (or fewer) similar commercials or invoking hyperlinks within ads or acting on other opportunities such as immediately to buy the advertised product. Such an action represents explicit and implicit feedback that may be pooled centrally and shared among all of the peer group devices for use in selecting ads.

By providing such features, rates that advertisers are willing to pay for ad insertions can be increased.

As shown in FIG. 1, a network element 10 acts as a source of ads to be inserted. The element 10 may receive the ads 14 from a wide variety of advertising sources 12 along with ad insertion principles 16 that define how and when the ads are to be inserted into television, radio, or other media elements to be presented to a user (in this description, the word user typically refers to both an individual and a household or other similar small group of users) on his peer group devices. The element 10 may be controlled by a wide variety of different parties including an Internet service provider (ISP), a television broadcaster, a cable operator, or a telephone company. The element 10 may distribute the ads and other video material through a wide variety of distribution mechanisms 18 (which we refer broadly as networks) to different end point devices 20. For example, telecommunications firms like AT&T, Sprint, and Comcast often own, control, or have rights to use digital subscriber lines (DSL), fiber networks, and radio frequency (RF) broadcast networks.

The element 10 delivers the ads to the end point devices using the networks. The advertising sources may use a wide variety of file-delivery protocols such as hypertext transfer protocol (HTTP) or file delivery over unidirectional transport (FLUTE, as formalized in Request for Comment (RFC) 3926). In the case of unidirectional networks, the source may also encode the files using a forward error-correction technique like Raptor (a technology available from Digital Fountain of Fremont Calif.).

The end point devices store the ads in local persistent storage 22, for example, a disk drive or Flash memory. The end points include ad selection logic 24 (in the form of hardware, software, or a combination of the two) to select one of the stored ads for presentation at an appropriate time. A presentation element 26 in each of the end points splices the ad into the video material in real time as the video material is being presented to the user. In some cases, the ad can be presented to the user separately from other video material, without requiring that it be spliced.

Each time an ad is selected and presented, the end point creates a new record 28 in a local usage data store 30. Each record in the store may contain a wide variety of information, including a unique identifier of the ad 32, a timestamp 34 indicating when the end point played the ad, and a unique identifier of the program 36 into which the endpoint inserted the ad.

From time to time, the end point device synchronizes 42 its local usage data store 30 with a remote master usage data store 40 by uploading its recently created records (thus, through the master usage data store, making the records available to other end point devices 50, 52 in the peer group 54) and, at the same time, downloading from the master usage data store recently created records from other devices in the peer group. The synchronizing may be done using, for example, secure socket layer (SSL) encrypted HTTP (GET and POST commands) or a proprietary scheme. Synchronizing the master usage data store with the end point devices is network intensive, but enables the ad selection logic in each of the end point devices to make better ad selections compared with not having information from the rest of the peer group.

When selecting which ad to show, each end point device will consult its local usage data store and apply logic that can take account of activities that have occurred not only in the local device but also in other devices that belong to the peer group.

The distribution mechanisms 18 can include various communication networks, and the network element can deliver the ads by multiplexing them through a multiplexer 70 onto the various networks from multiple sources. The multiplexer may include transcoding and resampling of the commercial, depending on the network and capabilities of end point devices. The networks may include unidirectional broadcast networks such as ATSC (advanced televisions systems committee), DVB-H (digital video broadcasting handhelds), and S-DMB (satellite digital multimedia broadcasting) and two-way networks such as TCP/IP (transmission control protocol/internet protocol): DSL, Ethernet, UMTS/HSDPA (universal mobile telephony system/high speed downlink packet access, EVDO (evolution data optimized), or GPRS (general packet radio service). Any particular user may have zero or more devices using each of the available networks.

The master usage data store contains a database aggregating usage data from all the end point devices and contains a unique person ID 60, one for each registered user, and the aggregated usage information 62 for each registered user, that is, a consolidated view of the data in all of the end point devices in that user's peer group).

The ads 14 and the ad insertion principles (which we also sometimes call splice instructions) are transmitted by the network element (which we also sometimes refer to as the head end) to the end point devices 20 out of band. Out of band includes sending the ads and as insertion principles on a different communication channel (including channels from sources, not shown, other than the head end) or at a different time on the same channel or on the same channel and the same time but in a multiplexed portion of the channel or in any other manner that is not incorporated within the video stream that contains the selected program or other video content.

The ads and splice instructions, like the video streams, may be broadcast or multicast on one or more channels, for example (but not necessarily), at the same time to the end point devices. The ads and splice instructions may come from sources other than the head end. In addition, different ads and splice instructions may be sent to different end point devices than the devices to which a given program is broadcast. For example, while a particular television program could be broadcast to everyone in the Boston metropolitan area, the ads and splice instructions that are sent to the same devices may differ by geographic sub-area, by user demographics, by nature of the devices to which they are sent, and in any of a wide variety of other ways. There need be no correlation between the different groups of devices to which programs are sent and the devices to which the ads and splice instructions are sent.

The programs (we sometimes use the word program to include television and radio programs and other video and audio content) sent to the end point devices contain splice point information that identifies the locations at which ads may be inserted. When a splice point appears in the video material, the end point device determines which ad to insert based on the splice instructions.

Splicing instructions can implement a wide variety of algorithms. For example, because the ads are inserted at presentation time, rather than at production time, splicing instructions can reduce the presentation of stale commercials (e.g. a commercial for an upcoming event that has already occurred by the time the recorded program is watched).

The usage data store and the master data store can contain a variety of additional information, including a list of the devices in each user's peer group, the characteristics of each device, the device associated with each record of ad presentation to the user, demographic information about the user, information about user interaction with the video in the case of interactive content, or actions taken by a user on the device after the ad was presented (for example, if the user called a telephone number that appeared in the ad). The ad sequence could be changed dynamically depending on the information about the user, the device, and the actions of the user. The information stored in the data stores may be provided from third party sources (for example, user information provided by a wireless carrier).

In the case of interactive television, the data store can hold information about user feedback such as “show me more (or fewer) commercials like this.” Some interactive television systems also provide hyperlinks within ads or other opportunities for viewers to interact with an advertisement (e.g. press “*” to immediately purchase the advertised product). A user performing such an action provides feedback information that may be stored and used by the end point devices in selecting ads for presentation.

In some implementations, ads may be stored securely on the end point devices in a format that prevents an unauthorized user (either the owner of the peer group or someone else) from erasing the files or from viewing or browsing the files.

In some embodiments, a tiered service can be provided in which the user can choose whether or not to accept presentation of commercials on his device with a higher subscription price applied to non-acceptance to compensate for the loss in advertising revenue. In some tiered service examples, the user may choose different service tiers for respective devices in the peer group, for example, allowing advertisements on his laptop but not on his mobile phone.

In some cases, the data stores can be synchronized during license retrieval. If a program is protected by a digital rights management (DRM) system, each end point device occasionally contacts a license distribution server for an updated license. The license exchange occurs over a two-way, typically TCP/IP-based network such as WLAN, Bluetooth, or WAN (GPRS, EV-DO, HSDPA, etc.). An end point device may have access to a two-way network only intermittently. Because data is transmitted during this process, two-way data synchronization of usage records can occur during this time while the network access is live.

In some implementations, advertisers wishing to guarantee proper sequencing may associate a group of ads with a mutex (not shown). Peer group end points will often have slightly inconsistent views of a total usage state. For example, an advertiser may request a set of ads to be sequenced (in an order 1, 2, 3 . . . ). If one end point shows ads 1 and 2 but has not yet reported this information to the centralized system, a second end point two, believing ad 1 has not been shown, will show ad 1. This results in the user experiencing the ad sequence 1, 2, and 1.

The mutex can exist in only one place (the network element or one end point) at one time. An end point device can display an ad from a sequence of ads only if the end point possesses the mutex. When the end point device releases the mutex by transmitting the mutex back to the server, the end point must also synchronize its recent usage information. Although the mutex forces the ads to be shown on only one device at a time, it guarantees that sequencing requirements are honored.

In some examples, the full peer group data is not replicated at each end point device. Instead, an end point device is required to query the master usage data store every time the end point wishes to insert an ad. The master store controls which ads are to be displayed. In this approach, the master database is not replicated on all end point devices. Also, the end point devices are not required to execute the splicing instructions. Because there can be extra latency in conducting a network operation and waiting for a response from the server, some dead air can occur immediately preceding the commercial. Splice-point predictions can minimize the dead air time by communicating with the network prior to the splice point cue.

In some implementations, the distribution mechanisms are configured in a point-to-point topology. Ads 32 are delivered separately to each end point device through various distribution channels (e.g., broadcast TV, mobile broadcast, 3G, DSL). Each device communicates with the master store independently using any available 2-way IP channel (e.g. WLAN, Ethernet, EVDO, GPRS).

In some embodiments, the distribution mechanisms are configured in a hub-and-spoke topology. In this topology, a household has a single point of entry such as a stationary, always-on set top box. Data is locally distributed from that box to the various devices using WLAN, Bluetooth, or other communication channel. Each device communicates with the local hub which acts as the network element. The local hub maintains a mirror of the master store. The local hub synchronizes with the master store using any available 2-way IP channel (for example, WLAN, Ethernet, EVDO, GPRS) Because the local hub is connected to the network element using a faster communication channel, the updates can be more frequent and, therefore, the database 114 can be more accurate.

In another specific example of how the techniques described here would be implemented, suppose that a user is associated with five peer group devices called p1, p2, p3, p4, and p5. Suppose that device p3 is currently active and accesses the following information (some of which possibly require access to mutex):

Advertisement history: which commercials a user has recently seen (on any of the devices) and when; and which commercials the user expressed some interest in (e.g. by accessing interactive elements in the commercial or ordering the product).

Media history: which shows the user has recently accessed (on all devices: p1, p2 . . . p5)

Location history (if available, e.g., from GPS units on some of the user's devices): Where the user has been recently.

Website history: Which URLs the user has accessed recently.

Specifications of current device: e.g., screen size and resolution, pixel depth, video capabilities, etc.

Current date/time

Currently-viewed program

Device p3 inspects its local store of commercials (previously transmitted and saved). Each commercial is annotated with an “insertion score function” that assigns a numeric value to the event in which the commercial is inserted in this context. This function may be implemented as a “bid” from the advertiser for insertion, parametrized by the variables listed above. In this sense, the mechanism bears some similarity to Google's “AdSense” program.

The device assigns a score to each commercial based on the contextual information above, just gathered, and selects the highest-scoring commercial to display.

In some examples, a content provider could annotate an advertisement (as part of the “delivery principle”) as being, for example, a “mobile only” or “home-only” or “car only” ad, in which case the ad would only be delivered to a mobile device, etc.

Other embodiments are within the scope of the following claims.

What is claimed is:

1. A method comprising
selecting an audio or video item to be presented on one occasion by an end point device to a user who is associated with the end point device, the selecting being based on information associated with a presentation of at least one other audio or video item at another end point device that is also associated with the user.

2. The method of claim 1 in which the selected audio or video item comprises an advertisement.

3. The method of claim 1 in which the one other audio or video item comprises an advertisement.

4. The method of claim 1 in which at least one of the end point devices comprises a cell phone, a personal digital assistant, or other handheld wireless device.

5. The method of claim 1 in which the information associated with the presentation comprises the timing of the presentation.

6. The method of claim 1 in which the information associated with the presentation comprises an identifier of the presentation.

7. The method of claim 1 in which the information associated with the presentation comprises information about other audio or video content presented at the other endpoint device.

8. The method of claim 1 in which the information associated with the presentation comprises information about the other endpoint device.

9. The method of claim 1 in which the information associated with the presentation comprises information about actions of the user.

10. The method of claim 1 also including storing the information associated with the presentation for use in connection with the selecting.

11. The method of claim 10 in which the information is stored in the end point device.

12. The method of claim 10 in which the information is stored in the other end point device.

13. The method of claim 10 in which the information is stored in a location accessible to both of the end point devices.

14. The method of claim 13 also including synchronizing storage of the information on both of the end point devices and at the accessible location.

15. The method of claim 13 in which the selecting is based on the information as stored in the accessible location.

16. The method of claim 13 in which accessible location contains a user identifier and usage information for the user.

17. The method of claim 1 in which the audio or video item is spliced into an audio or video stream.

18. The method of claim 17 in which the audio or video stream comprises a television program and the audio or video item that is spliced comprises an advertisement.

19. The method of claim 1 also including receiving the information at the end point device directly or indirectly from the other end point device.

20. The method of claim 1 in which the selecting includes controlling a sequence in which multiple audio and video items are presented to the user at more than one of the end point devices.

21. The method of claim 20 in which the sequence is controlled using a mutex.

22. The method of claim 1 also including communicating the information during a license retrieval.

23. A method comprising
controlling presentation to a user of two video advertisements at two different times and at two different presentation devices used by a single user so that one of the advertisements is reliably presented to the user before the other of the advertisements.

24. The method of claim 23 in which the presentation is controlled using a mutex.

25. A method comprising
using information associated with presentation of video material on a presentation device to a known user to select video material to be presented to the known user on another presentation device.

26. A method comprising
storing in a centrally accessible data store information about advertisements that have been presented to users at different presentation devices, and
using the stored information to select advertisements to be presented to the users at the different presentation devices.

27. A method comprising
enabling a single user of more than two devices at which video programs are to be presented to choose, independently for each device, whether or not to permit the device to present advertisements to the user in connection with the video programs.

28. An apparatus comprising
a data store to contain information about audio or video material presented to users of multiple presentation devices, the information including identifiers of the material presented, indications of times when the material was presented, and identifiers of the users.

29. An apparatus comprising
a handheld device on which advertisements are to be presented, the handheld device including a store containing information about presentations of advertisements that have been made to a user of the handheld device on other presentation devices.

30. A method comprising
selecting a media file to be presented on a user device based on a number of times the media file or another media file has been presented on the user device or on other devices of the user.

31. The method of claim 30 in which the media files comprise commercials.

32. The method of claim 30 in which the user device comprises a handheld phone, a personal digital assistant, a laptop computer, or a cable/satellite set top box.

33. The method of claim 31 in which the commercials have a predefined intended sequence of presentation.

34. The method of claim 30 in which the selecting of the media file is based on media file presentation history stored other than on the user device.
